(19) United States
(12) Patent Application Publication
(10) Pub. No.: US 2025/0084348 A1
(43) Pub. Date: Mar. 13, 2025

(54) DETERGENT COMPOSITIONS WITH SUSTAINABLE SOLVENTS AND MAILLARD REACTION INHIBITING ENZYMES

(71) Applicant: HENKEL AG & CO. KGAA, Düsseldorf (DE)

(72) Inventor: Daniel Thomas PIORKOWSKI, Fairfield, CT (US)

(21) Appl. No.: 18/828,561

(22) Filed: Sep. 9, 2024

Related U.S. Application Data
(60) Provisional application No. 63/537,062, filed on Sep. 7, 2023.

(51) Int. Cl. C11D 3/386; C11D 3/00; C11D 3/43; C11D 17/04

(52) U.S. Cl. CPC C11D 3/38654; C11D 3/0005; C11D 3/43; C11D 17/043; C11D 2111/12

(57) ABSTRACT

A detergent composition useful for laundry applications in both unit dose form and non-unit dose form is described. The detergent composition includes a Maillard reaction inhibiting enzyme that inhibits a reducing sugar present in a sustainable solvent from reacting with an amine source. The detergent composition which includes the enzyme does not undergo yellowing and thus has an increased shelf-life compared to an equivalent laundry detergent composition that lacks such an enzyme.

### CROSS-REFERENCE TO RELATED APPLICATION

This application claims the benefit of U.S. Provisional Application No. 63/537,062 filed Sep. 7, 2023, the entire contents of which are incorporated by reference herein.

### FIELD OF THE DISCLOSURE

The disclosure relates to detergents, and more particularly to laundry detergent compositions. The disclosure also relates to laundry detergent compositions in unit dose forms and non-unit dose forms having increased shelf-lives.

### BACKGROUND OF THE DISCLOSURE

In detergent compositions in both unit dose and non-unit dose forms, there is an ongoing trend to include sustainable materials therein. Sustainable materials are derived from renewable, recycled and waste carbon sources and their combination, which at the end of life can be recycled, biodegraded, or composted. Sustainable materials also exhibit reduced environmental impact throughout their life cycle. The use of sustainable materials within detergent compositions can reduce the cost of formulating the detergent composition and can provide an environmentally friendly product.

In some instances, the sustainable material (i.e., raw material) used in formulating the detergent composition includes a reducing sugar, such as, for example, fructose or glucose. The reducing sugar can be a contaminant (i.e., residual) in the sustainable material or it can be part (i.e., a moiety) of the sustainable material, for example, a monomer of a polymer, which degrades from the sustainable material over time.

Reducing sugars undergo a Maillard reaction and cause browning in products when in the presence of amines and heat. In laundry detergents, amines can be present in the form of, for example, monoethanolamine (which is used as a neutralizer) or enzymes (e.g., proteins). Browning reactions cause detergent compositions to turn yellow over time, especially when stored at elevated temperatures such as, for example, from 35° C. to 50° C. In some cases, it has been observed that as little as 40 ppm of reducing sugars can cause browning reactions to occur within a detergent composition over time.

The discoloration, for example, yellowing, of detergent compositions caused by the Maillard reaction can lead to consumer dissatisfaction and consumer apprehension that the detergent compositions are no longer useable. Thus, there is a need for providing non-yellowing detergent compositions in both unit-dose form and non-unit-dose form.

### SUMMARY OF THE DISCLOSURE

Various aspects of the disclosure are directed to detergent compositions useful for laundry applications in both unit dose forms and non-unit dose forms. Detergent compositions according to the disclosure include an enzyme that inhibits a reducing sugar present in a sustainable solvent from reacting with an amine source. The enzyme prevents a Maillard reaction from occurring and thus is referred to herein as a “Maillard reaction inhibiting enzyme”. Detergent compositions according to the disclosure which include a Maillard reaction inhibiting enzyme do not undergo yellowing and thus have increased shelf-lives compared to equivalent laundry detergent compositions that lack such an enzyme. Since yellowing is prevented, consumer confidence in detergent compositions according to the disclosure would be improved.

In accordance with various aspects of the disclosure, detergent products are provided. In accordance with various aspects of the disclosure, the detergent products can be in a unit dose form. In some instances, the detergent products comprise a container made of a water-soluble or water-dispersible film, and detergent compositions encapsulated in the container. In accordance with various aspects of the disclosure, the containers can be a pouch, a pod or a pack (or pac). In some instances, the detergent compositions that are encapsulated in the container comprise at least one surfactant, a sustainable solvent including a reducing sugar, an amine source that can react with the reducing sugar, a Maillard reaction inhibiting enzyme that inhibits reaction between the amine source and the reducing sugar, and water. In some instances, water is present in the compositions in an amount from about 5 weight percent to about 45 weight percent.

In accordance with various aspects of the disclosure, the reducing sugar can be a residual contaminant present in the sustainable solvent, or it can be a moiety of the sustainable solvent that can be released upon degradation. Degradation of the reducing sugar can occur during formulation and storage, especially when a detergent composition is stored at elevated temperatures.

In some instances, detergent compositions that are encapsulated in the container can consist essentially of at least one surfactant, a sustainable solvent including a reducing sugar, an amine source that can react with the reducing sugar, a Maillard reaction inhibiting enzyme that inhibits reaction between the amine source and the reducing sugar, and water.

In some instances, detergent compositions that are encapsulated in the container can consist of at least one surfactant, a sustainable solvent including a reducing sugar, an amine source that can react with the reducing sugar, a Maillard reaction inhibiting enzyme that inhibits reaction between the amine source and the reducing sugar, and water.

In accordance with various aspects of the disclosure, liquid detergent compositions are also provided. In accordance with the disclosure, liquid detergent compositions can represent a non-unit dose form. In some instances, liquid detergent compositions according to the disclosure comprise at least one surfactant, a sustainable solvent including a reducing sugar, an amine source that can react with the reducing sugar, a Maillard reaction inhibiting enzyme that inhibits reaction between the amine source and the reducing sugar, and water. In some instances, water is present in an amount ranging from about 20 to about 95 weight percent of the liquid detergent composition.

In some instances, the liquid detergent compositions can consist essentially of at least one surfactant, a sustainable solvent including a reducing sugar, an amine source that can react with the reducing sugar, a Maillard reaction inhibiting enzyme that inhibits reaction between the amine source and the reducing sugar, and water.

In some instances, the liquid detergent compositions can consist of at least one surfactant, a sustainable solvent including a reducing sugar, an amine source that can react with the reducing sugar, a Maillard reaction inhibiting enzyme that inhibits reaction between the amine source and the reducing sugar, and water.

In some instances, the amine source can include an ethanolamine compound, a chelating agent, an amino acid, an amine-containing enzyme or combinations thereof.

In some instances, the sustainable solvent can include sorbitol, xylitol, mannitol, lactitol, isomalt, maltitol, a hydrogenated starch hydrolysate, sucrose, stachyose, verbascose, trehalose, raffinose or combinations thereof.

In some instances, the reducing sugar can include fructose, glucose, hexose, lactose, glyceraldehyde, arabinose, maltose, galactose, ribose, xylose, cellobiose or combinations thereof.

In some instances, the Maillard reaction inhibiting enzyme can include hexose oxidase, fructosamine oxidase, fructosamine kinase, carbohydrate oxidase or combinations thereof.

In some instances, the Maillard reaction inhibiting enzyme is typically present in the detergent compositions in an amount ranging from about 0.001 weight percent to about 3 weight percent.

In some instances, the sustainable solvent is typically present in the detergent composition in an amount of from about 0.01 weight percent to about 60 weight percent.

### BRIEF DESCRIPTION OF THE DRAWINGS

FIG. 1 is an image depicting the yellow pantone scale for the yellowing of detergent compositions from reducing sugar agents.

### DETAILED DESCRIPTION

The present disclosure will now be described in greater detail by referring to the following discussion and drawings that accompany the present disclosure. In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. As used throughout the present disclosure, the term “about” generally indicates no more than ±10%, ±5%, ±2%, ±1% or ±0.5% from a number. When a range is expressed in the present disclosure as being from one number to another number (e.g., 20 to 40), the present disclose contemplates any numerical value that is within the range (i.e., 22, 24, 26, 28.5, 31, 33.5, 35, 37.7, 39 or 40) or any in amount that is bounded by any of the two values that can be present within the range (e.g., 28.5-35).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this disclosure, specify the presence of stated features, integers, steps, operations, elements, and/or components, but do not preclude the presence or addition of one or more other features, integers, steps, operations, elements, components, and/or groups thereof.

Detergent compositions according to various aspects of the disclosure are provided, which are useful for laundry applications in both unit dose forms and non-unit dose forms that have an increased shelf-lives. Detergent compositions according to various aspects of the disclosure can include at least one surfactant, a sustainable solvent including a reducing sugar, an amine source that can react with the reducing sugar, a Maillard reaction inhibiting enzyme that inhibits reaction between the amine source and the reducing sugar, and water. As discussed herein, the presence of such an enzyme in a detergent composition inhibits the Maillard reaction between the reducing sugar and the amine source and thus increasing the shelf-life of the detergent composition. The increased shelf-life is evidenced by the absence of yellowing of the detergent composition over an extended period of time. In the present disclosure, the enzyme inhibits the reaction of the reducing sugar with the amine source throughout the entire shelf-life of the detergent composition including at the beginning of the formulation process. These and other aspects of the present disclosure will now be described in greater detail.

As stated above, detergent compositions of according to the disclosure include at least one surfactant. The at least one surfactant is present in the detergent composition in an amount from about 5 weight percent to about 70 weight percent of the detergent composition, alternatively in an amount from about 15 weight percent to about 65 weight percent of the detergent composition, and alternatively in an amount from about 20 weight percent to about 50 weight percent of the detergent composition. In the present disclosure, all weight percents are based on the total weight of the detergent composition unless otherwise specified.

In some instances, the at least one surfactant can include an anionic surfactant, a non-ionic surfactant, a cationic surfactant, a semi-polar surfactant, a zwitterionic surfactant or combinations thereof. In some embodiments, the at least one surfactant includes one or more anionic surfactants and one or more non-anionic surfactants. In instances where two or more surfactants are employed, the combination of surfactants can be referred to as a surfactant system.

In some instances, the at least one surfactant is an anionic surfactant. When an anionic surfactant is present, the anionic surfactant can be present in the detergent composition in an amount from about 2 weight percent to about 35 weight percent of the detergent composition, alternatively in an amount from amount from about 8 weight percent to about 25 weight percent of the detergent composition, and alternatively in an amount from about 15 weight percent to about 20 weight percent of the detergent composition. Non-limiting examples of anionic surfactants that can be employed in the present disclosure include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diyIbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or salt of fatty acids (soap), or combinations thereof.

Various classes of anionic surfactants may be used. In some instances, the anionic surfactant can be a linear alkyl sulfonate (LAS) or a linear alkylbenzene sulfonate (LABS). LAS and LABS are water soluble salts between 8 and 22 carbon atoms in the alkyl group. In some instances, suitable LAS and/or LABS compounds may include salts of C₈-C₁₈ alkyl sulfonic acids and salts of C₈-C₁₈ alkylbenzyl sulfonic acids. In some instances, the anionic surfactant is a linear alkyl ether (or laureth) sulfonate. In some instances, suitable linear alkyl ether sulfonates include a linear C₈-C₁₈ alkyl chain, 4-9 repeating ethylene oxide units, and an anionic head group made up of the sulfonate group and a counter cation. Suitable counter cations for LAS, LABS and linear alkyl ether sulfonates can be, but are not necessarily limited to, Na⁺, K⁺, and NH₄⁺. In some instances, the anionic surfactant is sodium or potassium lauryl sulfate or a sodium or potassium lauryl ether sulfate.

In some instances, the at least one surfactant is a nonionic surfactant. When a nonionic surfactant is present, the nonionic surfactant can be present in the detergent composition in an amount from about 2 weight percent to about 30 weight percent of the detergent composition, alternatively in an amount from amount from about weight percent to about 25 weight percent of the detergent composition, and alternatively in an amount from about 15 weight percent to about 20 weight percent detergent composition. Non-limiting examples of nonionic surfactants that can be employed in the present disclosure include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA).

Various classes of nonionic surfactants may be used. In some instances, suitable nonionic surfactants include, but are not limited to, alkoxylated alcohols, polyoxyalkylene alkyl ethers, polyoxyalkylene alkylphenyl ethers, polyoxyalkylene sorbitan fatty acid esters, polyoxyalkylene sorbitol fatty acid esters, polyalkylene glycol fatty acid esters, alkyl polyalkylene glycol fatty acid esters, polyoxyethylene polyoxypropylene alkyl ethers, polyoxyalkylene castor oils, polyoxyalkylene alkylamines, glycerol fatty acid esters, alkylglucosamides, alkylglucosides, alkylamine oxides, or any combinations thereof.

In some instances, the least one surfactant is a cationic surfactant. When a cationic surfactant is present, the cationic surfactant can be present in the detergent composition in an amount from about 2 weight percent to about 35 weight percent, alternatively in an amount from amount from about 8 weight percent to about 25 weight percent, and alternatively in an amount from about 15 weight percent to about 20 weight percent. Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium compounds, alkyl quaternary ammonium compounds, alkoxylated quaternary ammonium (AQA) compounds, ester quats, or combinations thereof.

In some instances, the least one surfactant is a one semipolar surfactant. Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, or combinations thereof. In some embodiments, the least one surfactant is a zwitterionic surfactant. Non-limiting examples of zwitterionic surfactants that can be employed include betaines such as alkyldimethylbetaines, sulfobetaines, or combinations thereof. When a semipolar surfactant and/or a zwitterionic surfactant are present, each of the semipolar surfactant and/or the zwitterionic surfactant can be present in the detergent composition in an amount from about 2 weight percent to about 35 weight percent of the detergent composition, alternatively in an amount from about 8 weight percent to about 25 weight percent of the detergent composition, and alternatively in an amount from about 15 weight percent to about 20 weight of the detergent composition.

In some instances, the at least one surfactant is a surfactant system that includes a fatty alcohol ethoxylate C₁₂₋₁₅ 7EO (non-ionic surfactant) and sodium laureth sulfate (anionic surfactant). In some instances, the at least one surfactant is a fatty alcohol ethoxylate. In some instances, the fatty alcohol ethoxylate is in an amount ranging from about 10 to about 50 wt % of the detergent composition. In some instances, the fatty alcohol ethoxylate is in an amount ranging from about 15 to about 35 wt % of the detergent composition. In some instances, the fatty alcohol ethoxylate is in an amount ranging from about 15 to about 20 wt % of the detergent composition.

As stated above, in some instances, detergent compositions according to the disclosure also include at least one amine source. The amine source can be present in the detergent composition in an amount from about 5 weight percent to about 30 weight percent of the detergent composition, alternatively in an amount from about 10 weight percent to about 25 weight percent of the detergent composition, and alternatively in an amount from about 12 weight percent to about 20 weight percent of the detergent composition. The amine source can be any compound that contains at least one amine functional group and that can be used in laundry detergent formulations. For example, the amine source can include, but is not limited to, an ethanolamine compound, a chelating agent, amino acid, an amine containing enzyme or any combination thereof. For example, a combination of an amino acid and an ethanolamine compound can be present in a detergent composition according to the disclosure.

Ethanolamine compounds contain a group of amino alcohols. Ethanolamine compounds can be used as a surfactant in some detergent compositions. Ethanolamine compounds can aid in the removal of dirt, grease and stains. Illustrative examples of ethanolamine compounds include, but are not limited to, monoethanolamine, diethanolamine, triethanolamine or mixtures thereof. In some instances, the ethanolamine is present in an amount ranging from about 0.5 to about 10 wt % of the detergent composition. In some instances, the ethanolamine is present in an amount ranging from about 1.0 to about 5.0 wt % of the detergent composition. In some instances, the ethanolamine is in an amount ranging from about 1.0 to about 2.5 wt % of the detergent composition.

A chelating agent is a compound containing a ligand (typically organic) that can react with metal ions to form a stable, water-soluble complex. Chelating agents can also be referred to as chelants, chelators or sequestering agents. Chelating agents can have a ring-like center which forms at least two bonds with the metal ion. In the present disclosure, the chelate is any compound that includes at least an amine functional and that can be used in laundry detergent formulations. Exemplary chelates that can be employed in the present disclosure as the amine source include, but are not limited to, tetrasodium iminodisuccinate, ethylenediamine, ethylenediaminetetraacetic (EDTA) or mixtures thereof. In some instances, the chelating agent is iminodisuccinic acid, ethylenediaminetetraacetic acid (EDTA), nitrilotriacetic acid, diethylenetriaminepenta(methylenephosphonic acid), nitrilotris(methylenephosphonic acid), 1-hydroxyethane-1,1-diphosphonic acid, ethylenediamine-N,N′-disuccinic acid (EDDS), hydroxyethylenediaminetriacetic acid (HEDTA), N,N-bis(carboxymethyl)-L-glutamic acid, Alanine, N,N-bis(carboxymethyl)-alanine, any suitable salts thereof of these acids, or other suitable chelating compounds comprising an amine group.

In some instances, the chelating agent is in an amount ranging from about 0.01 to about 5.0 wt % of the detergent composition. In some instances, the chelating agent is in an amount ranging from about 0.5 to about 2.5 wt % of the detergent composition.

Amino acids are organic compounds that contain both amino and carboxylic functional groups. Exemplary amino acids that can be used as the amine source include, but are not limited to, arginine, histidine, lysine, aspartic acid, glutamic acid, serine, threonine, asparagine, glutamine, cysteine, selenocysteine, glycine, proline, alanine, valine, isoleucine, methionine, phenylalanine, tyrosine, tryptophan or any combination thereof.

Amine-containing enzymes (i.e., enzymes that containing at least one amine functionality) can also be used as the amine source.

As stated above, detergent compositions according to the disclosure can further include a sustainable solvent that includes a reducing sugar. In some instances, the sustainable solvent can be present in the detergent composition in an amount of from about 0.01 weight percent to about 60 weight percent of the detergent composition. In some instances, the sustainable solvent can be present in the detergent composition in an amount of from about 1 weight percent to about 30 weight percent of the detergent composition. In some instances, the sustainable solvent can be present in the detergent composition in an amount from about 5 weight percent to about 20 weight percent of the detergent composition.

As mentioned above, sustainable solvents according to the disclosure can include a reducing sugar. In some instances, the reducing sugar can be a contaminate (residual) or it can be a moiety of the sustainable solvent that can be released upon degradation. In detergent compositions according to the disclosure including an amine source, the reducing sugar (residual or released) and the amine source can react together under heat to cause unwanted yellowing of the detergent composition. In some instances, the reducing sugar is present in the sustainable solvent in an amount of from about 0.0001 weight percent to about 1 weight percent of the sustainable solvent, alternatively in an amount of from about 0.005 weight percent to about 0.5 weight percent of the sustainable solvent.

A reducing sugar is any sugar that can act as a reducing agent. In some instances, the reducing sugar can include a monosaccharide or disaccharide. Exemplary reducing sugars that can be contained in the sustainable solvent include, but are not limited to, fructose, glucose, hexose, lactose, glyceraldehyde, arabinose, maltose, galactose, ribose, xylose, cellobiose or combinations thereof. The reducing sugar can be present in the raw materials that are used in forming the sustainable solvent mentioned above.

As mentioned above, in some instances, the detergent compositions can further comprise a Maillard reaction inhibiting enzyme. In accordance with various aspects of the disclosure, the Maillard reaction inhibiting enzyme is any enzyme that can prevent yellowing of the detergent composition by inhibiting the reaction (i.e., Maillard reaction) between the reducing sugar and the amine source. In some instances, the Maillard reaction inhibiting enzyme can be present in the detergent composition in an amount from about 0.001 weight percent to about 3 weight percent of the detergent composition, alternatively in an amount of from about 0.005 weight percent to about 0.5 weight percent of the detergent composition, and alternatively in an amount from about 0.01 weight percent to about 0.1 weight percent of the detergent composition. In some instances, the Maillard reaction inhibiting enzyme is a reducing sugar oxidation enzyme. Such oxidation enzymes oxidize the reducing sugar that is present and prevent subsequent yellowing of the detergent composition from occurring. In some instances, the Maillard reaction inhibiting enzyme is an enzyme that reacts with fructose and glucose since they are commonly used in producing sustainable polymers. Illustrative examples of Maillard reaction inhibiting enzymes that can prevent yellowing of the detergent composition include, but are not limited to, hexose oxidase, fructosamine oxidase, fructosamine kinase, or carbohydrate oxidase. It is noted that within the range mentioned above, the Maillard reaction inhibiting enzyme can prevent the Maillard reaction from occurring throughout the entire shelf-life of the detergent composition.

Detergent compositions according to the disclosure can further comprise water. The amount of water present in a detergent composition according to the disclosure can vary depending on whether the detergent composition is in a unit dose form or a non-unit dose form.

In some instances, detergent compositions according to the disclosure have a pH in a range from about 6 to about 12. In some instances, detergent compositions according to the disclosure have a pH from about 6.5 to about 10. In some instances, the pH can be selected to enhance the efficacy of the Maillard reaction inhibiting enzyme.

It is noted that reducing sugars can be contained in other raw materials that are used in formulating detergent compositions. In some instances, these reducing sugars can be a residual contaminant present in the other raw materials, or it can be a moiety of the raw material that can be released upon degradation. For example, a reducing sugar can be contained in a sustainable polymer that can be used in formulating a detergent composition. In some instances, the reducing sugar is present in a laundry detergent raw material that is made from a fermentation reaction. Such reactions have residual reducing sugars such as, for example, glucose or fructose, leftover. In some instances, the amino acids used as the amine source itself can be produced by a fermentation reaction and thus the amino acids themselves can contain residual reducing sugars. Maillard reaction inhibiting enzymes, as described herein, inhibit the Maillard reaction of the amine source with the reducing sugars contained in these other raw materials.

In addition to the above-mentioned components, detergent compositions in accordance with the disclosure can include any additional detergent components that are known in the art. Other optional detergent components include, for example, beaching systems, anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, and wicking agents, either alone or in combination. Any component known in the art for use in detergents may be utilized. The choice of such optional components and the working amounts is well within the skill of the artisan.

In some instances, detergent compositions in accordance with various aspects of the disclosure can further include well known dye transfer agents, fluorescent whitening agents, soil release polymers, rheology modifiers or any combination thereof. In some instances, detergent compositions of the disclosure can also include a fatty acid that has a formula R—C(O)OH, wherein R is a C₅-C₂₁ linear or branched aliphatic group. In one example, the fatty acid is dodecanoic acid (also known as coconut fatty acid).

In some instances, detergent compositions according to various aspects of the disclosure can further comprise an anti-redeposition polymer. In some instances, anti-redeposition agents include polymers with a soil detachment capacity, which are also known as “soil repellents” due to their ability to provide a soil-repelling finish on the treated surface, such as a fibers. In some instances, the anti-redeposition polymer is in an amount ranging from about 0.1 to about 1 wt % of the detergent composition. In some instances, the anti-redeposition polymer is an acrylic/styrene copolymer. In some instances, the anti-redeposition polymer can be a polyester. In some instances, the polyesters include co-polyesters prepared from dicarboxylic acids, such as adipic acid, phthalic acid or terephthalic acid. In some instances, an anti-redeposition agent includes polyesters with a soil detachment capacity that include those compounds which, in formal terms, are obtainable by esterifying two monomer moieties, the first monomer being a dicarboxylic acid HOOC-Ph-COOH and the second monomer a diol HO—(CHR—)ₐOH, which may also be present as a polymeric diol H—(O—(CHR—)ₐ)_{b}OH. “Ph” here means an ortho-, meta- or para-phenylene residue that may bear 1 to 4 substituents selected from alkyl residues with 1 to 22 C atoms, sulfonic acid groups, carboxyl groups and mixtures thereof, “R” means hydrogen or an alkyl residue with 1 to 22 C atoms and mixtures thereof, “a” means a number from 2 to 6 and “b” means a number from 1 to 300. In some instances, the polyesters obtainable therefrom may contain not only monomer diol units —O—(CHR—)aO— but also polymer dial units —(O—(CHR—)ₐ)_{b}O—. In some instances, the molar ratio of monomer diol units to polymer diol units may amount to from about 100:1 to about 1:100, or alternatively from about 10:1 to about 1:10. In some instances, the polymer diol units, the degree of polymerization “b” may be in the range of from about 4 to about 200, or alternatively from about 12 to about 140. In some instances, the number average molecular weight of the polyesters with a soil detachment capacity may be in the range of from about 250 to about 100,000, or alternatively from about 500 to about 50,000. In some instances, the acid on which the residue Ph is based may be selected from terephthalic acid, isophthalic acid, phthalic acid, trimellitic acid, mellitic acid, the isomers of sulfophthalic acid, sulfoisophthalic acid and sulfoterephthalic acid and mixtures thereof. In some instances, the acid groups thereof are not part of the ester bond in the polymer, they may be present in salt form, such as an alkali metal or ammonium salt.

In some instances, instead of the monomer HOOC-Ph-COOH, polyesters with a soil detachment capacity (the anti-redeposition agent) may include small proportions, for example up to about 10 mole percent relative to the proportion of Ph with the above-stated meaning, of other acids that include at least two carboxyl groups. These include, for example, alkylene and alkenylene dicarboxylic acids such as malonic acid, succinic acid, fumaric acid, maleic acid, glutaric acid, adipic acid, pimelic acid, suberic acid, azelaic acid and sebacic acid. Exemplary diols HO—(CHR—)ₐOH include those in which R is hydrogen and “a” is a number of from about 2 to about 6, and in some instances those in which “a” has the value of 2 and R is selected from hydrogen and alkyl residues with 1 to 10 C atoms, or where R is selected from hydrogen and alkyl residues with 1 to 3 C atoms in another embodiment. Examples of diol components include ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol and neopentyl glycol. The polymeric diols may include polyethylene glycol with an average molar mass in the range from about 1000 to about 6000. In some instances, these polyesters may also be end group-terminated, with end groups that may be alkyl groups with 1 to 22 C atoms or esters of monocarboxylic acids. The end groups attached via ester bonds may be based on alkyl, alkenyl and aryl monocarboxylic acids with 5 to 32 C atoms, or alternatively with 5 to 18 C atoms. These may include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselinic acid, petroselaidic acid, oleic acid, linoleic acid, linolaidic acid, linolenic acid, eleostearic acid, arachidic acid, gadoleic acid, arachidonic acid, behenic acid, erucic acid, brassidic acid, clupanodonic acid, lignoceric acid, cerotic acid, melissic acid, benzoic acid, which may bear 1 to 5 substituents having a total of up to 25 carbon atoms, or alternatively 1 to 12 carbon atoms, for example tert-butylbenzoic acid. The end groups may also be based on hydroxymonocarboxylic acids with 5 to 22 carbon atoms, which for example include hydroxyvaleric acid, hydroxycaproic acid, ricinoleic acid, the hydrogenation product thereof, hydroxystearic acid, and ortho-, meta- and para-hydroxybenzoic acid. The hydroxymonocarboxylic acids may in turn be joined to one another via their hydroxyl group and their carboxyl group and thus be repeatedly present in an end group. The number of hydroxymonocarboxylic acid units per end group, i.e. their degree of oligomerization, may be in the range of from 1 to 50, or alternatively in the range of from 1 to 10. In some instances, polymers of ethylene terephthalate and polyethylene oxide terephthalate, in which the polyethylene glycol units have molar weights of from about 750 to about 5000 and the molar ratio of ethylene terephthalate to polyethylene oxide terephthalate of from about 50:50 to about 90:10, can be used alone or in combination with cellulose derivatives.

In some instances, dose unit products comprising a detergent composition according to various aspects of the disclosure includes sodium sulfite. Sodium sulfite is an oxygen scavenger, where sodium sulfite reacts with oxygen to form sodium sulfate. Free oxygen, such as oxygen dissolved in the detergent composition, can react to produce metal oxides (rust) that reduce the life of the washing equipment. The metal oxides can also stain garments, dishes, or other items being washed. Dissolved oxygen can also react to produce other components, and some of those components may be colored bodies. Therefore, the sodium sulfite can help reduce the formation of colored bodies in the detergent composition. However, sodium sulfite includes sodium, and sodium-containing compounds tend to produce efflorescent solids in the film. In some instances, the sodium sulfite is in an amount from about 0.05 to about 4 wt %, alternatively from about 0.05 to about 3 wt %, alternatively from about 0.05 to about 2 wt % of the detergent composition.

In some instances, unit dose products comprising a detergent composition according to various aspects of the disclosure may include an optical brightener. Optical brighteners adsorb ultraviolet and/or violet light and re-transmit it as visible light, typically a visible blue light. Optical brighteners include, but are not limited to, derivatives of diaminostilbene disulfonic acid or alkali metal salts thereof. Suitable compounds are, for example, salts of 4,4′-bis(2-anilino-4-morpholino-1,3,5-triazinyl-6-amino)stilbene 2,2′-disulfonic acid or compounds of similar structure which, instead of the morpholino group, bear a diethanolamino group, a methylamino group, an anilino group or a 2-methoxyethylamino group. Optical brighteners of the substituted diphenylstyryl type may furthermore be present, such as the alkali metal salts of 4,4′-bis(2-sulfostyryl)diphenyl, 4,4′-bis(4-chloro-3-sulfostyryl)diphenyl, or 4-(4-chlorostyryl)-4′-(2-sulfostyryl)diphenyl. Mixtures of the above-stated optical brighteners may also be used. In some instances, optical brighteners may be present in detergent compositions in an amount ranging about 0.01 to about 0.5 wt %, alternatively from about 0.01 to about 1 wt %, alternatively from about 0.01 to about 3 wt %, or alternatively from 0.01 to about 5 wt % of the detergent composition.

In some instances, unit dose products comprising a detergent composition according to various aspects of the disclosure may include one or more foam inhibitors (i.e., defoamers). In some instances, foam inhibitors include, for example, fatty acids such as coconut fatty acids. In some instances, suitable foam inhibitors include, for example, soaps of natural or synthetic origin (which may exhibit elevated proportions of C₁₈-C₂₄ fatty acids), organopolysiloxanes and mixtures thereof with microfine (and optionally silanized) silica, paraffins, waxes, microcrystalline waxes and mixtures thereof with silanized silica or bis-fatty acid alkylenediamides (for example, bistearylethylenediamide), silicones, and combinations thereof. In some instances, foam inhibitors may be present in detergent compositions in an amount ranging about 0.01 to about 0.5 wt %, alternatively from about 0.01 to about 0.1 wt %, alternatively from about 0.01 to about 3 wt %, or alternatively from 0.01 to about 5 wt % of the detergent composition.

In some instances, detergent compositions according to various aspects of the disclosure may further comprise a bittering agent to hinder accidental ingestion of the composition. Bittering agents are compositions that taste bad, so children or others are discouraged from accidental ingestion. Generally, the type of bittering agent used is not limited to any particular compounds. Suitable bittering agents include, but are limited to denatonium benzoate, denatonium saccharide, sucrose octaacetate, capsicum, aloin, or others. In some instances, the bittering agent is in an amount ranging from about 0.01 to about 0.5 wt % of the detergent composition. In some instances, the bittering agent is in an amount ranging from about 0.015 to about 0.4 wt %, alternatively from about 0.02 to about 0.3 wt %, alternatively from about 0.025 to about 0.2 wt %, alternatively from about 0.03 to about 0.1 wt %, alternatively from about 0.035 to about 0.075 wt %, and alternatively from about 0.04 to about 0.06 wt % of the detergent composition. In some instances, detergent compositions according to various aspects of the disclosure may further comprise a fatty acid. In some instances, the fatty acid is in an amount ranging from about 2 to about 10 wt % of the detergent composition. In some instances, the fatty acid is in an amount ranging from about 1 to about 12 wt % of the detergent composition. In some instances, the fatty acid is coconut fatty acid. In some instances, the fatty acid may be one of lauric acid, myristic acid, palmitic acid, stearic acid, ricinoleic acid, oleic acid, linoleic acid, or linolenic acids.

In some instances, detergent compositions according to various aspects of the disclosure may further comprise a lauryl sulfate and/or a lauryl ether sulfate. In some instances, the lauryl sulfate and/or lauryl ether sulfate is in an amount ranging from about 2 to about 8 wt % of the detergent composition.

In some instances, detergent compositions according to various aspects of the disclosure can further include at least one other enzyme besides the Maillard reaction inhibiting enzyme mentioned above. The at least one other enzyme can enhance the cleaning performance (including, for example, stain removal, redeposition of soil released in the washing/cleaning process, or restoration, fully or partially, of the whiteness of a textile) of other components that are present in the detergent composition in accordance with various aspects of the disclosure. Exemplary enzymes other than Maillard reaction inhibiting enzymes include, but are not limited to, deoxyribonucleases (DNaeses), cellulases, proteases, lipases, cutinases, amylases, peroxidases, and/or oxidases.

Detergent composition according to the disclosure can be formulated utilizing techniques well known to those skilled in the art. In some instances, the various components that provide detergent composition can be added in any order. For example, a sustainable solvent including a reducing sugar can be added to vessel including at least one surfactant, water and the amine source, and thereafter a Maillard reaction inhibiting enzyme can be added to the vessel. In some instances, the addition is a metered addition. Alternatively, a Maillard reaction inhibiting enzyme can be added to a reactor vessel including a sustainable solvent including a reducing sugar and the amine source, and thereafter water and at least one surfactant can be added. The addition of the various components that provide the detergent composition of the present disclosure can be performed with continuous stirring. The addition is typically performed at room temperature, e.g., from about 20° C. to about 30° C. In some instances, an enzyme enhancing agent can be added during the formulation process to improve the performance of the Maillard reaction inhibiting enzyme. In some instances, the Maillard reaction inhibiting enzyme can be added to a previously formulated detergent composition that includes at least one surfactant, an amine source, a sustainable solvent including a reducing sugar and water that has been stored for some period of time.

In some instances, detergent compositions according to the disclosure can be in a unit dose form. In such instances, a detergent product is provided that includes a container and a detergent composition, as defined above, that comprises, consists essentially of, or consists of at least one surfactant, a sustainable solvent including a reducing sugar, an amine source that can react with the reducing sugar, a Maillard reaction inhibiting enzyme that inhibits reaction between the amine source and the reducing sugar, and water.

The container may be a pouch, a pod or a pack (or pac) made from a water-soluble or water-dispersible polymer film, which encloses the detergent composition of the present disclosure. The water-soluble or water-dispersible container can be in any desirable shape and size, e.g., square, rectangular, oval, elliptoid, super-elliptical, or circular shape.

In some instances, the container of the unit dose form is formed from a water-soluble or water-dispersible polymer film. Non-limiting examples of water-soluble or water-dispersible polymers include polyvinyl alcohol, cellulose ethers, polyethylene oxide, starch, polyvinylpyrrolidone, polyacrylamide, polyacrylonitrile, polyvinyl methyl ether-maleic anhydride, polymaleic anhydride, styrene maleic anhydride, hydroxyethylcellulose, methylcellulose, polyethylene glycol, carboxymethylcellulose, polyacrylic acid salts, alginates, acrylamide copolymers, guar gum, casein, ethylene-maleic anhydride resins, polyethyleneimine, ethyl hydroxyethylcellulose, ethyl methylcellulose, hydroxyethyl methylcellulose, film forming cellulosic polymer, polyanhydride, polysaccharide, polyalkylene oxide, cellulose, cellulose ester, cellulose amide, polyvinyl acetate, polycarboxylic acid and salt, polyaminoacid, polyamide, natural gums, polyacrylate, water-soluble acrylate copolymer, methylcellulose, carboxymethylcellulose sodium, dextrin, ethylcellulose, maltodextrin, polymethacrylate, polyvinyl alcohol copolymer, and combinations thereof.

In some instances, the water-soluble or water-dispersible film material of the container may be polyvinyl alcohol, polyvinyl acetate, film forming cellulosic polymer, polyacrylic acid, polyacrylamide, polyanhydride, polysaccharide, or a mixture thereof. In some instances, the water-soluble or water-dispersible film material is polyvinyl alcohol or polyvinyl acetate. In some instances, the water-soluble or water-dispersible container is made from a lower molecular weight water-soluble polyvinyl alcohol film-forming resin.

In some instances, the water-soluble or water-dispersible container can further contain a cross-linking agent. In some instances, the cross-linking agent can be boric acid or sodium borate.

The film material of the container can have a thickness of between about 50 microns to about 120 microns, alternatively a thickness between about 60 microns to about 100 microns. In some instances, the film material of the container can have a thickness of between about 50 microns to about 130 microns.

The water-soluble or water-dispersible container of a unit dose form can be prepared in any suitable way, such as via molding, casting, extruding or blowing, and is then filled using an automated filling process, as known in the prior art.

Detergent compositions that can be used in a unit dose forms include (i) a detergent composition according to the disclosure; and (ii) a solvent system. The solvent system can consist of water, a non-aqueous solvent (NAS), and a residual solvent present in an amount of 0 to 5 percent by weight of the composition. In some instances, the NAS can include a single NAS. In some instances, the NAS can include more than one non-aqueous solvent. The residual solvent is neither water nor the NAS. Each of water and the NAS is present in an amount of more than 5 percent by weight of the detergent composition, with the solvent system totals from about 30% to about 80% by weight of the detergent composition.

In some instances, the solvent system comprises from about 37.5% to about 70%, alternatively from about 40% to about 65%, and alternatively from about 50% to about 60%, based on the total weight of the detergent composition. In some instances, the solvent system is present in an amount of from 37.5% to about 40%, from about 40% to about 45%, from about 45% to about 50%, from about 50% to about 55%, from about 55% to about 60%, from about 60% to about 65%, from about 65% to about 70%, from about 70% to about 75%, or from about 75% to about 80%, by weight of the detergent composition.

In some instances, two or three non-aqueous solvents are greater than 5% wt. are present in the liquid composition. In some instances, the NAS is present from about 10% to about 70%, alternatively from about 20% to about 65%, alternatively from about 25% to about 60%, alternatively from about 30% to about 55%, and alternatively from about 40% to about 55%, based on the total weight of the detergent composition. In some instances, the NAS is in an amount ranging from about 10 to about 80 wt % of the detergent composition.

In some instances, the NAS is present in an amount of from about 10% to about 20%, from 20% to about 30%, from about 30% to about 40%, from about 40% to about 50%, from about 50% to about 60%, from about 60% to about 70%, by weight of the detergent composition.

In some instances, the NAS is present in an amount of about 25%, from 22% to about 27%, from 28% to about 35%, from about 33% to about 43%, or from about 40% to about 45%, by weight of the detergent composition. In some instances, the NAS is in an amount ranging from about 15 to about 40 wt % of the detergent composition. In some instances, the NAS is in an amount ranging from about 10 to about 50 wt % of the detergent composition.

In some instances, the NAS may be chosen from ethanol; polyethylene glycol; polypropylene glycol; polypropylene glycol esters; polyethylene glycol esters such as polyethylene glycol stearate, polyethylene glycol laurate, and/or polyethylene glycol palmitate; methyl ester ethoxylate; diethylene glycol; dipropylene glycol; sorbitol; tetramethylene glycol; butylene glycol; pentanediol; hexylene glycol; heptylene glycol; octylene glycol; 2-methyl-1,3-propanediol; xylitol; mannitol; erythritol; dulcitol; inositol; adonitol; triethylene glycol; glycol ethers, such as ethylene glycol monobutyl ether, diethylene glycol monobutyl ether, triethylene glycol monobutyl ether, ethylene glycol monopropyl ether, diethylene glycol monoethyl ether, triethylene glycol monoethyl ether, diethylene glycol monomethyl ether, and triethylene glycol monomethyl ether; tris (2-hydroxyethyl)methyl ammonium methylsulfate; ethylene oxide/propylene oxide copolymers with the non-aqueous solvent has a weight average molecular weight of 4000 Daltons or less.

In some instances, the NAS is selected from polyethylene glycol; polyethylene glycol esters such as polyethylene glycol stearate, polyethylene glycol laurate, and/or polyethylene glycol palmitate; polyproylene glycol.

In some instances, the NAS is glycerol (glycerin), ethylene glycol, ethanol, or a 4C+ compounds. The term “4C+ compound” refers to one or more of: polyethylene glycol esters such as polyethylene glycol stearate, propylene glycol laurate, and/or propylene glycol palmitate; ethyl ester ethoxylate; diethylene glycol; dipropylene glycol; tetramethylene glycol; butylene glycol; pentanediol; hexylene glycol; heptylene glycol; octylene glycol; 2-methyl-1,3-propanediol; triethylene glycol; glycol ethers, such as ethylene glycol monobutyl ether, diethylene glycol monobutyl ether, triethylene glycol monobutyl ether, ethylene glycol monopropyl ether, diethylene glycol monoethyl ether, triethylene glycol monoethyl ether, diethylene glycol monomethyl ether, and triethylene glycol monomethyl ether; tris (2-hydroxyethyl)methyl ammonium methylsulfate; ethylene oxide/propylene oxide copolymers with a number average molecular weight of 3,500 Daltons or less; and ethoxylated fatty acids. In some instances, the non-aqueous solvent is or includes a relatively low molecular weight polyethylene glycol (PEG). In some instances, the polyethylene glycol has a molecular weight ranging from about 200 to about 1000 g/mol (or Daltons), alternatively a molecular weight ranging from about 200 to about 800 g/mol, or alternatively a molecular weight of about 400 g/mol. In some instances, the polyethylene glycol has a weight average molecular weight of less than about 600 Da, e.g. about 400, such as those having a weight average molecular weight of from about 380 to about 420 Da. In other instances, PEG-200, PEG-250, PEG-300, PEG-350, PEG-400, PEG-450, PEG-500, PEG-550, and/or PEG-600 (wherein the numerals represent the approximate weight average molecular weight in Daltons or grams/mol) may be used. In some instances, the non-aqueous solvent is or includes an ethylene oxide/propylene oxide block copolymer. In some instances, the NAS is or includes a polyol such as glycerin. In some instances, the non-aqueous solvent is or includes a mixture of a polyol and a polyethylene glycol. In some instances, the polyol in the mixture is glycerin. Suitable polyol/polyethylene glycol mixtures may have a polyol to polyethylene glycol weight:weight ratio ranging from about 10:1 to about 1:10, alternatively from about 9:1 to about 1:9, alternatively from about 8:1 to about 1:8, alternatively from about 7:1 to about 1:7, alternatively from about 6:1 to about 1:6, alternatively from about 5:1 to about 1:5, alternatively from about 4:1 to about 1:4, alternatively from about 3:1 to about 1:3, alternatively from about 2:1 to about 1:2, alternatively from about 1.5:1 to about 1:1.5, and alternatively about 1:1

In some instances, the NAS is polyethylene glycol (“PEG”) and/or an ester thereof. The PEG can have a weight average molecular weight ranging, for example, from about 100 to about 4000 Daltons. Suitable PEGs can have a weight average molecular weight of, for example, about 300, about 400, about 500, about 600, about 700, about 800, about 900, about 1000, about 1100, about 1200, about 1300, about 1400, about 1500, about 1600, about 1700, about 1800, about 1900, about 2000, about 2100, about 2200, about 2300, about 2400, about 2500, or about 2600, about 2700, about 2800, about 2900, about 3000, about 3500, or about 4000 Daltons. Suitable polyol/polyethylene glycol mixtures may have a polyol to polyethylene glycol weight:weight ratio ranging from about 10:1 to about 1:10, alternatively from about 9:1 to about 1:9, alternatively from about 8:1 to about 1:8, alternatively from about 7:1 to about 1:7, alternatively from about 6:1 to about 1:6, alternatively from about 5:1 to about 1:5, alternatively from about 4:1 to about 1:4, alternatively from about 3:1 to about 1:3, alternatively from about 2:1 to about 1:2, alternatively from about 1.5:1 to about 1:1.5, and alternatively about 1:1.

In some instances, the NAS is PEG-100 stearate, PEG-400, or PEG-3350. In other instances, the NAS is PEG-400 in an amount of from about 20% to about 45% by weight of the detergent composition; while water is present in an amount of from about 10% to about 30% by weight of the detergent composition.

The water in a detergent composition of a unit-dose form can be derived from added water or water accompany a component that forms the raw material that is used in formulating the detergent composition. In some instances, the total water amount presented in the detergent composition is from about 5% to about 45%, alternatively from about 10% to about 40%, alternatively from about 15% to about 35%, alternatively from about 20% to about 40%, alternatively from about 25% to about 35%, and alternatively from about 25% to about 30%, based on the total weight of the detergent composition.

In some instances, water is present in an amount of from about 5% to about 10%, from 10% to about 15%, from about 15% to about 20%, from about 20% to about 25%, from about 25% to about 30%, from 30% to about 35%, from about 35% to about 40%, or from about 40% to about 45%, by weight of the detergent composition. In some instances, water is in an amount ranging from about 20 to about 90 wt % of the detergent composition.

In some instances, water is present in an amount of from 11% to about 16%, from 17% to about 23%, or from about 22% to about 32%, by weight of the detergent composition.

In some instances, the weight ratio of water to the NAS is from 1:4 to 4:1, from 1:3 to 3:1, from 1:3 to 2:1, from 1:2 to 2:1, or about 1:1. In other embodiments, the weight ratio of water to the NAS is from 1:1 to 4:1, from 1:1 to 3:1, or from 1:1 to 2:1. In further embodiments, the weight ratio of water to the NAS is about 0.5:1, about 0.8:1, about 1:1, about 1:1, about 1.2:1, about 1.3:1, or about 1.5:1.

The term “residual solvent(s)” generally refer to a solvent that is introduced into the detergent composition by the addition of an ingredient (i.e., a commercial product containing the ingredient and the residual solvent), where the residual solvent is less than 5% by weight of the detergent composition. In some instances, the residual solvent is less than 5% wt, or less than 3% wt, or less than 1% wt.

The residual solvent is neither water nor the NAS. In some instances, the residual solvent is a mono-ol or di-ol with a low molecular weight. For example, the residual solvent may be ethanol. The existence of the residual solvent does not interfere with the performances of the solvent system.

As mentioned above, in some instances, detergent compositions according to the disclosure can be encapsulated in a container made of a water-soluble or water-dispersible film. The solubility of the film in water should be moderated to keep the film structurally sound prior to use. In some instances, the inclusion of a non-aqueous solvent of certain type in the detergent composition moderates the solubility of the film, thereby protecting the film from being dissolved by water incorporated in the detergent composition. As such, adding the non-aqueous solvent to the detergent composition allows for unit dose pacs where the detergent composition therein includes water present in amounts of up to about 45%, by the weight of the detergent composition. It also allows for unit dose pacs where the detergent composition therein includes contain a high total solvent content, up to about 80%, by the weight of the detergent composition without compromising pack rigidity.

Formulations according to the disclosure can also include at least one impurity, a pH adjusting agent, a preservative, or any combination thereof. When at least one impurity is present, the at least one impurity can be present in a formulation in an amount of from about 0.2 weight percent or less, alternatively in an amount of about 1 ppm or less. Illustrative examples of impurities that can be present include, but are not limited to, alkylene glycols (such as, for example, diethylene glycol and/or ethylene glycol), metals (such as, for example, Ni, Pt, and/or Pd), and any combination thereof. Generally, the at least one impurity is not intentionally added to the formulation, but instead can be a leftover material that is present in the raw material composition.

When a pH adjusting agent (or buffer) is present, the pH adjusting agent can be present in a formulation in an amount of from about 1 weight percent or less. Illustrative examples of pH adjusting agents that can be present in a formulation according to the disclosure include, but are not limited to, acids and/or bases. Illustrative acids that can be used include, but are not limited to, citric acid, and/or acetic acid. In some instances, the acid can be, for example, lactic acid, stearic acid, palmitic acid or oleic acid.

In some instances, the pH adjusting agent is a base. Illustrative bases that can be used include, but are not limited to, KOH and/or NaOH. In some instances, the base is calcium oxide. When present, the pH adjusting agent is employed to adjust the formulation containing the raw material composition to a desired pH. In some cases, the pH adjusting agent can also affect the stability, efficacy and performance of other components present in the formulation. The pH adjusting agent can be added utilizing techniques that are well known to those skilled in the art. The formulation of the present disclosure typically has a pH from 6 to 12, alternatively a pH from 6.5 to 10.

In some instances, detergent compositions according to the disclosure can be in a liquid detergent form (i.e., a non-unit dose form). In some instances, liquid detergent forms can comprise at least one surfactant, a sustainable solvent including a reducing sugar, an amine source that can react with the reducing sugar, a Maillard reaction inhibiting enzyme that inhibits reaction between the amine source and the reducing sugar, and water. In such embodiments, the detergent composition can contain at least 20 percent by weight and up to 95 percent by weight water, alternatively up to about 70 percent by weight water, alternatively up to about 65 percent by weight water, alternatively up to about 55 percent by weight water, alternatively up to about 45 percent by weight water, alternatively up to about 35 percent by weight water. Other types of solvents, besides water including, for example, organic solvents comprising alkanols, amines, diols, ethers and/or polyols can also be included in a non-unit dose liquid detergent composition according to the disclosure. The organic solvent can be present in the liquid detergent composition according to the disclosure in an amount from about 0 percent by weight, up to, and including, 30 percent by weight.

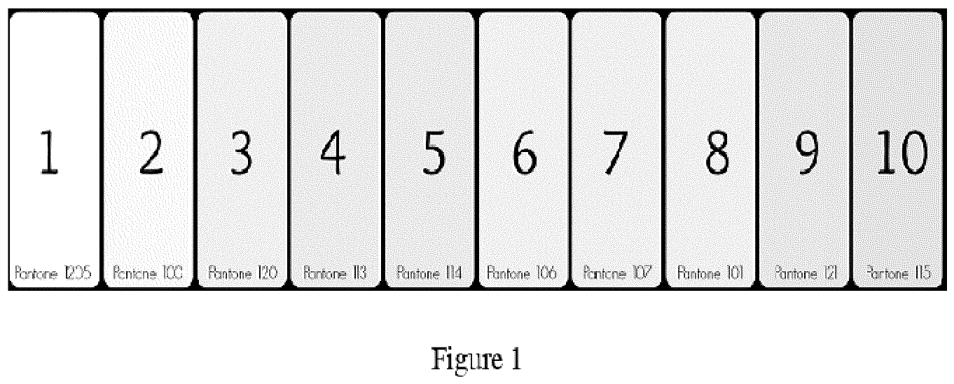

In accordance with various aspects of the disclosure, the yellowing in a detergent composition, such as a liquid laundry detergent composition, can be measured through the pantone color systems. FIG. 1 displays the numerical representation of each color of yellow. Table 1 is also the tabular representation of FIG. 1.

TABLE 1

| Numerical Representation | Pantone Number |
|---|---|
| 1 | Pantone 1205 |
| 2 | Pantone 100 |
| 3 | Pantone 120 |
| 4 | Pantone 113 |
| 5 | Pantone 114 |
| 6 | Pantone 106 |
| 7 | Pantone 107 |
| 8 | Pantone 101 |
| 9 | Pantone 121 |
| 10 | Pantone 115 |

Examples have been set forth below for the purpose of further illustrating the present disclosure. The scope of the present disclosure is not limited to any of the examples set forth herein.

### Example 1

Liquid detergent compositions were prepared by mixing the components in the amounts listed in Table 2. Notably, the detergent compositions were batched using a standard overhead mixer, target pH 7.5 to 8. Formula 1 and Formula 2 of Table 2 are identical in composition except that Formula 2 included a Maillard reaction inhibiting enzyme as described herein, while the Maillard reaction inhibiting enzyme was omitted from Formula 1. Both formulas included two reducing sugar sources, the first is sorbitol and the second is the polysaccharide. Formula 1 is a comparative example (namely Cell), while Formula 2 is an example in accordance with an embodiment of the present disclosure.

TABLE 2

| | Raw | Wt % of | Wt % of |
|---|---|---|---|
| | Material | Formula 1 | Formula 2 |
| Component | Activity | (CE1) | (Inventive) |
| Water, demineralized | 100 | q/s to 100 | q/s to 100 |
| | | (about 39.328) | (about 38.578) |
| Citric acid | 50 | 4.5 | 4.5 |
| Sodium tetraborate 5H₂O | 100 | 0.5 | 0.5 |
| 50% NaOH | 50 | 2.4 | 2.4 |
| Fatty alcohol ethoxylate | 100 | 18 | 18 |
| (Laureth, 6 EO) | | | |
| Sodium Lauryl Sulfate | 29 | 30 | 30 |
| Maillard Reaction Inhibiting | 100 | 0 | 0.05 to 1 |
| Enzyme | | | |
| Polysaccharide Performance | 40 | 1.5 | 1.5 |
| Polymer | | | |
| Sorbitol Solvent | 70 | 5 | 5 |
| Coconut Fatty Acid, Anti- | N/A | 5.28 | 5.28 |
| redeposition Polymer, | | | |
| Chelant, Preservative, | | | |
| Aqueous Enzyme Solution | | | |
| (Protease, Amylase, | | | |
| Mannanase blend) | | | |

### Example 2

Liquid detergent compositions were prepared by mixing the components in the amounts listed in Table 3. Notably, the detergent compositions were batched using a standard overhead mixer, target pH 11-12. Formula 3 and Formula 4 of Table 3 are identical in composition except that Formula 4 included a Maillard reaction inhibiting enzyme as described herein, while the Maillard reaction inhibiting enzyme was omitted from Formula 3. Thus, Formula 3 is a comparative example (namely CE2), while formula 4 is an example in accordance with an embodiment of the present disclosure.

TABLE 3

| | Raw | Wt % of | Wt % of |
|---|---|---|---|
| | Material | Formula 3 | Formula 4 |
| Component | Activity | (CE 2) | (Inventive) |
| Water | 100% | q/s | q/s |
| Nonionic surfactant | Approx. | 17.14 | 17.14 |
| (fatty alcohol ethoxylate C₁₂₋₁₅ 7EO) | 88% as | | |
| and Anionic surfactant | a blend | | |
| (sodium laureth sulfate, 3EO) | | | |
| Anionic surfactant / Defoamer | 100% | 10.95 | 10.95 |
| (coconut fatty acid | | | |
| derived from palm) and | | | |
| sodium carbonate and Optical | | | |
| Brightener and Anti-Redeposition | | | |
| Polymer and Preservative | | | |
| Chelant | 34% | 1.18 | 1.18 |
| (tetrasodium iminodisuccinate) | | | |
| Sorbitol | 70% | 5 | 5 |
| Maillard Reaction Inhibiting Enzyme | 100 | 0 | 0.05 to 1 |

### Example 3

Liquid detergent compositions were prepared by mixing the components in the amounts listed in Table 4, pH target of 7.7. The detergent compositions in this example are meant to be encapsulated in a polyvinyl acetate (PVA) film. Formula 5 and Formula 6 of Table 4 are identical in composition except that Formula 6 included a Maillard reaction inhibiting reaction enzyme as described herein, while the Maillard reaction inhibiting enzyme was omitted from Formula 5. Thus, Formula 5 is a comparative example (namely CE3), while Formula 6 is an example in accordance with an embodiment of the present disclosure.

TABLE 4

| | Wt % of | Wt % of |
|---|---|---|
| | Formula 5 | Formula 6 |
| COMPONENT | (CE3) | (Inventive) |
| Non-Aqueous Solvents | QS to 100 | QS to 100 |
| (Polyethylene Glycol 400, Propylene | | |
| Glycol, Glycerin, Ethanol blend) | | |
| Fatty alcohol ethoxylate (25-7) | 23.07 | 23.07 |
| Monoethanolamine | 6.04 | 6.04 |
| Water | 6.50 | 6.50 |
| Linear alkylbenzene sulfonic acid | 17 | 17 |
| Coconut Fatty Acid | 10 | 10 |
| Alcohol ethoxy sulfate, 3EO | 4.8 | 4.8 |
| Sodium Iminodisuccinate (Chelant) | 0.6 | 0.6 |
| Sodium Sulfite, Optical | 1.58 | 1.58 |
| Brightener, Bittering Agent | | |
| Sorbitol | 10 | 10 |
| Maillard Reaction Inhibiting Enzyme | 0 | 0.05 to 1 |
| Final Total | 100 | 100 |

### Example 4

Liquid detergent compositions were prepared by mixing the components in the amounts listed in Table 5. Formula 7 is a comparative example in that the formulation lacks a Maillard reaction inhibiting enzyme as described herein. Formula 8 and Formula 9 are both inventive since they both include a Maillard reaction inhibiting enzyme.

TABLE 5

| | Wt % of | Wt % of | Wt % of |
|---|---|---|---|
| | Formula 7 | Formula 8 | Formula 9 |
| COMPONENT | (CE4) | (Inventive) | (Inventive) |
| Glycerin | QS to 100 | QS to 100 | QS to 100 |
| 25-7 Alcohol Ethoxylate | 23.07 | 23.07 | 23.07 |
| Nonionic Surfactant | | | |
| Non-Aqueous Solvent | 17.01 | 20.51 | 20.51 |
| (Polyethylene Glycol 400, | | | |
| Propylene Glycol, | | | |
| Ethanol Blend | | | |
| 50% Sodium Hydroxide | 0 | 1.86 | 1.86 |
| Monethanolamine | 4.80 | 0 | 0 |
| Water | 10.5 | 9.19 | 9.19 |
| Optical Brighter, Fatty | 8.08 | 8.08 | 8.08 |
| Acid, Chelant, Sodium | | | |
| Sulfite, and Bittering Agent | | | |
| Biosoft S-101 LAS | 17 | 0 | 0 |
| Diane AES 3EO- 70% Paste | 4.8 | 4.8 | 4.8 |
| MEE C1810EO | 0 | 17 | 0 |
| Alkyl Sulfate 23S70 | 0 | 0 | 17 |
| C12-13; (70% Active) | | | |
| Sorbitol 70% Active | 10 | 10 | 10 |
| Maillard Reaction | 0 | 0.05 to 1 | 0.05 to 1 |
| Inhibiting Enzyme | | | |
| Total | 100 | 100 | 100 |

### Example 5

Liquid detergent compositions were prepared by mixing the components in the amounts listed in Table 6. Formula 10 and Formula 11 are both inventive since they both include a Maillard reaction inhibiting enzyme.

TABLE 6

| | Wt % of | Wt % of |
|---|---|---|
| | Formula 10 | Formula 11 |
| COMPONENT | (Inventive) | (Inventive) |
| Glycerin | QS to 100 | QS to 100 |
| 25-7 Alcohol Ethoxylate Nonionic Surfactant | 23.07 | 23.07 |
| Propylene Glycol | 8.21 | 0 |
| PEG400 | 26.3 | 24.6 |
| 50% Sodium Hydroxide | 1.86 | 1.86 |
| Water | 9.19 | 9.19 |
| Optical Brighter, Fatty Acid, Chelant, | 8.08 | 8.08 |
| Sodium Sulfite, and Bittering Agent | | |
| Diane AES 3EO- 70% Paste | 4.8 | 4.8 |
| Sorbitol 70% Active | 10 | 10 |
| Maillard Reaction Inhibiting Enzyme | 0.05 to 1 | 0.05 to 1 |
| SDA-3C Ethanol (200 Proof) | 3 | 3 |
| Total | 100 | 100 |

### Example 6

Formulae 12-15 were created by mixing components in the amount listed in Tables 7 and 8. Notably, the Formulae 12-15 were batched using a standard overhead mixer for one house. Glucose was added to the batch to illustrate the inclusion of reducing sugar in the sustainable material (for example, sorbitol, which can exhibit lot to lot variation in the % of residual glucose). The rest of the materials were added after. If the hexose oxidase was added at the batch (instead of treating the sustainable material and glucose up front), a significant benefit was not seen.

TABLE 7
Unit Dose Detergent Example

| | Active | Formula 12 | Formula 13 |
|---|---|---|---|
| Ingredient | % | (wt %) | (wt %) |
| Water | 100 | 24.35 | 24.4 |
| Sorbitol | 70 | 5 | 5 |
| Glucose | 100 | 0.1 | 0.1 |
| Hexose Oxidase | 100 | 0.05 | 0 |
| Glycerin | 99 | 25 | 25 |
| Alcohol Ethoxylate 25-7 | 100 | 35 | 35 |
| Ethanol | 100 | 2.5 | 2.5 |
| Fatty Acid | 100 | 4 | 4 |
| MEA | 100 | 1 | 1 |
| QS/additional MEA | 100 | 3 | 3 |
| Total | | 100 | 100 |

TABLE 8
Liquid Detergent Example

| | Active | Formula 14 | Formula 15 |
|---|---|---|---|
| Ingredient | % | (wt %) | (wt %) |
| Water | 100 | 78.35 | 78.4 |
| Sorbitol | 70 | 2 | 2 |
| Glucose | 100 | 0.1 | 0.1 |
| Hexose Oxidase | 100 | 0.05 | 0 |
| Alcohol Ethoxylate 25-7 | 100 | 15 | 15 |
| Fatty Acid | 100 | 0.5 | 0.5 |
| MEA | 100 | 1 | 1 |
| QS/additional MEA | 50 | 3 | 3 |
| Total | | 100 | 100 |

Formulas 12-15 were placed in a stability chamber at 25° C. or 37° C. Yellow color was observed after 1 month of stability. Formulae 12 and 14 (included the Hexose Oxidase) showed a color benefit over Formulae 13 and 15 (did not include the Hexose Oxidase) as seen in Table 8.

TABLE 8

| Formula # | Pantone Color Ranking (0-10)* |
|---|---|
| Formula 12 (1 month at 25 C.) | 0 |
| Formula 13 (1 month at 25 C.) | 1 |
| Formula 12 (1 month at 37 C.) | 5 |
| Formula 13 (1 month at 37 C.) | 10 |
| Formula 14 (1 month at 25 C.) | 0 |
| Formula 15 (1 month at 25 C.) | 0 |
| Formula 14 (1 month at 37 C.) | 1 |
| Formula 15 (1 month at 37 C.) | 6 |

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A unit dose detergent product comprising:
a pouch comprising at least one chamber, the pouch being made of a water-soluble material; and
a detergent composition encapsulated within the at least one chamber, the detergent composition comprising:
at least one surfactant in an amount of from about 15 to about 35 wt % of the detergent composition;
a sustainable solvent comprising a reducing sugar in an amount of from about 0.01 to about 60 wt % of the detergent composition;
an amine source in an amount of from about 5 to about 30 wt % of the detergent composition;
a Maillard reaction inhibiting enzyme in an amount of from about 0.01 to about 3 wt % of the detergent composition; and
water in an amount of from about 5 to about 45 wt % of the detergent composition.

2. The unit dose detergent product of claim 1, wherein the amine source is selected from the group consisting of an ethanolamine compound, a chelating agent, an amino acid, an amine containing enzyme, and any combination thereof.

3. The unit dose detergent product of claim 1, wherein the sustainable solvent is selected from the group consisting of sorbitol, xylitol, mannitol, lactitol, isomalt, maltitol, a hydrogenated starch hydrolysate, sucrose, stachyose, verbascose, trehalose, raffinose, and combination thereof.

4. The unit dose detergent product of claim 1, wherein the reducing sugar is selected from the group consisting of fructose, glucose, hexose, lactose, glyceraldehyde, arabinose, maltose, galactose, ribose, xylose, cellobiose, and any combination thereof.

5. The unit dose detergent product of claim 1, wherein the Maillard reaction inhibiting enzyme is selected from the group consisting of hexose oxidase, fructosamine oxidase, fructosamine kinase, carbohydrate oxidase, and any combination thereof.

6. The unit dose detergent product of claim 1, wherein the sustainable solvent is in an amount from about 1 to about 30 wt % of the detergent composition.

7. The unit dose detergent product of claim 6, wherein the sustainable solvent is in an amount of from about 5 to about 20 wt % of the detergent composition.

8. The unit dose detergent product of claim 1, further comprising at least one of:
a base in an amount of from about 0.01 to about 2 wt % of the detergent composition;
a weak acid in an amount of from about 0.01 to about 2 wt % of the detergent composition;
a chelating agent in an amount of from about 0.1 to about 2.5 wt % of the detergent composition;
a lauryl sulfate or a lauryl ether sulfate in an amount of from about 2 to about 8 wt % of the detergent composition; or
a fatty acid in an amount of from about 0.5 to about 5 wt % of the detergent composition.

9. The unit dose detergent product of claim 1, wherein the at least one surfactant is selected from the group consisting of nonionic surfactants, cationic surfactants, anionic surfactants, zwitterionic surfactants, and any combination thereof.

10. The unit dose detergent product of claim 1, wherein the detergent composition has a pH of from about 6 to about 12.

11. A liquid detergent composition comprising:
at least one surfactant in an amount of from about 15 to about 35 wt % of the liquid detergent composition;
a sustainable solvent comprising a reducing sugar in an amount of from about 0.01 to about 60 wt % of the liquid detergent composition;
an amine source in an amount of from about 5 to about 30 wt % of the liquid detergent composition;
a Maillard reaction inhibiting enzyme in an amount of from about 0.01 to about 3 wt % of the liquid detergent composition; and
water in an amount of from about 20 to about 95 wt % of the liquid detergent composition.

12. The liquid detergent composition of claim 11, wherein the amine source is selected from the group consisting of an ethanolamine compound, a chelating agent, an amino acid, an amine containing enzyme, and any combination thereof.

13. The liquid detergent composition of claim 11, wherein the sustainable solvent is selected from the group consisting of sorbitol, xylitol, mannitol, lactitol, isomalt, maltitol, a hydrogenated starch hydrolysate, sucrose, stachyose, verbascose, trehalose, raffinose, and any combination thereof.

14. The liquid detergent composition of claim 11, wherein the reducing sugar is selected from the group consisting of fructose, glucose, hexose, lactose, glyceraldehyde, arabinose, maltose, galactose, ribose, xylose, cellobiose, and any combination thereof.

15. The liquid detergent composition of claim 11, wherein the Maillard reaction inhibiting enzyme is selected from the group consisting of hexose oxidase, fructosamine oxidase, fructosamine kinase, carbohydrate oxidase, and any combination thereof.

16. The liquid detergent composition of claim 11, further comprising at least one of:
a base in an amount of from about 0.01 to about 2 wt % of the liquid detergent composition;
a weak acid in an amount of from about 0.01 to about 2 wt % of the liquid detergent composition;
a chelating agent in an amount of from about 0.1 to about 2.5 wt % of the liquid detergent composition;
a lauryl sulfate or a lauryl ether sulfate in an amount of from about 2 to about 8 wt % of the liquid detergent composition; or
a fatty acid in an amount of from about 0.5 to about 5 wt % of the liquid detergent composition.

17. The liquid detergent composition of claim 11, wherein the at least one surfactant is selected from the group consisting of nonionic surfactants, cationic surfactants, anionic surfactants, zwitterionic surfactants, and any combination thereof.

18. The liquid detergent composition of claim 11, wherein the sustainable solvent is present in an amount of from about 1 to about 30 wt % of the liquid detergent composition.

19. The liquid detergent composition of claim 11, wherein the sustainable solvent is present in an amount of from about 5 to about 20 wt % of the liquid detergent composition.

20. The liquid detergent composition of claim 11, wherein the detergent composition has a pH of from about 6 to about 12.
